(19) United States
(12) Patent Application Publication
(10) Pub. No.: US 2026/0176832 A1
(43) Pub. Date: Jun. 25, 2026

(54) SYSTEM AND METHOD FOR DETERMINING MATERIAL COMPACTION VALUE

(71) Applicant: Caterpillar Paving Products Inc., Brooklyn Park, MN (US)

(72) Inventor: Nicholas Alan Oetken, Brooklyn Park, MN (US)

(73) Assignee: Caterpillar Paving Products Inc., Brooklyn Park, MN (US)

(21) Appl. No.: 18/988,288

(22) Filed: Dec. 19, 2024

(51) Int. Cl. E01C 23/01; E01C 19/28; G01P 15/18

(52) U.S. Cl. CPC E01C 23/01; E01C 19/288; G01P 15/18; E01C 2301/30

(57) ABSTRACT

A system for determining a material compaction value associated with a compaction operation being performed by a compactor includes at least one accelerometer coupled to a drive motor of the compactor. The at least one accelerometer is configured to generate an input signal indicative of an acceleration of the drive motor. The system also includes a controller communicably coupled with the at least one accelerometer. The controller is configured to receive, from the at least one accelerometer, the input signal indicative of the acceleration of the drive motor. The controller is also configured to determine the material compaction value associated with the compaction operation based on the input signal indicative of the acceleration of the drive motor.

### TECHNICAL FIELD

The present disclosure relates to a compactor, and more particularly, to a system for determining a material compaction value associated with a compaction operation being performed by the compactor and a method for determining the material compaction value associated with the compaction operation being performed by the compactor.

### BACKGROUND

A compactor is used for compacting materials like asphalt, soil, aggregates, clay, concrete, and/or other such materials. The compactor includes one or more drums that contact the materials to be compacted. Each drum is equipped with a vibration system that vibrates the corresponding drum at a desired vibrating frequency and a desired vibrating amplitude to compact the materials.

Conventionally, the compactor includes an accelerometer mounted on the drum to calculate and monitor compaction levels of the material being compacted. The accelerometer mounted on the drum is a separate component and may require a wire harness to provide power and transmit signals to a controller of the compactor, which may increase part numbers associated with the compactor. Incorporation of the accelerometer on the drum may increase a cost and a complexity associated with the compactor, as the accelerometer requires its own hardware for operation.

U.S. Pat. No. 4,103,554 describes a device for ascertaining the degree of compaction of beds of material with a vibratory compaction device as a function of the vibratory amplitude of the motion of the compaction device at selected frequencies. The amplitude of vibratory motion of a compaction device is measured at a fundamental frequency and at least the second harmonic of the fundamental frequency and a ratio of the measured signals is computed. The ratio or quotient of the two signals provides a representation of the degree of compaction of the material being compressed by the compaction device. The ratio or quotient may be utilized either as a direct indication to an operator of the degree of compaction or as a control signal in an automated servo control compaction system.

### SUMMARY OF THE DISCLOSURE

In an aspect of the present disclosure, a system for determining a material compaction value associated with a compaction operation being performed by a compactor is provided. The system includes at least one accelerometer coupled to a drive motor of the compactor. The at least one accelerometer is configured to generate an input signal indicative of an acceleration of the drive motor. The system also includes a controller communicably coupled with the at least one accelerometer. The controller is configured to receive, from the at least one accelerometer, the input signal indicative of the acceleration of the drive motor. The controller is also configured to determine the material compaction value associated with the compaction operation based on the input signal indicative of the acceleration of the drive motor.

In another aspect of the present disclosure, a compactor is provided. The compactor includes a frame. The compactor also includes a drum coupled to the frame. The compactor further includes a vibration system disposed within the drum and adapted to vibrate the drum. The vibration system includes a drive motor. The compactor includes a system for determining a material compaction value associated with a compaction operation being performed by the compactor. The system includes at least one accelerometer coupled to the drive motor of the compactor. The at least one accelerometer is configured to generate an input signal indicative of an acceleration of the drive motor. The system also includes a controller communicably coupled with the at least one accelerometer. The controller is configured to receive, from the at least one accelerometer, the input signal indicative of the acceleration of the drive motor. The controller is also configured to determine the material compaction value associated with the compaction operation based on the input signal indicative of the acceleration of the drive motor.

In yet another aspect of the present disclosure, a method for determining a material compaction value associated with a compaction operation being performed by a compactor is provided. The method includes coupling at least one accelerometer to a drive motor of the compactor. The method also includes generating, by the at least one accelerometer, an input signal indicative of an acceleration of the drive motor. The method further includes receiving, by a controller, the input signal indicative of the acceleration of the drive motor from the at least one accelerometer. The controller is communicably coupled with the at least one accelerometer. The method includes determining, by the controller, the material compaction value associated with the compaction operation based on the input signal indicative of the acceleration of the drive motor.

Other features and aspects of this disclosure will be apparent from the following description and the accompanying drawings.

### BRIEF DESCRIPTION OF THE DRAWINGS

FIG. 1 is a schematic side view of a compactor, according to an example of the present disclosure;

FIG. 2 is a block diagram of a system for determining a material compaction value associated with a compaction operation being performed by the compactor of FIG. 1, according to an example of the present disclosure; and

FIG. 3 is a flowchart of a method for determining the material compaction value associated with the compaction operation being performed by the compactor of FIG. 1, according to an example of the present disclosure.

### DETAILED DESCRIPTION

Wherever possible, the same reference numbers will be used throughout the drawings to refer to the same or like parts.

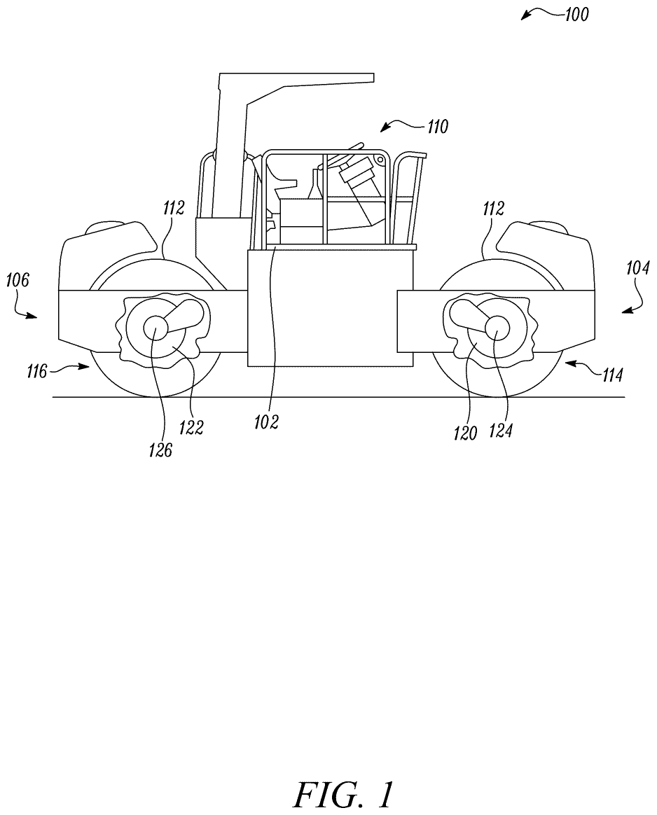

Referring to FIG. 1, a schematic side view of a compactor 100 is illustrated. The compactor 100 may be a soil compactor, an asphalt compactor, a concrete compactor, a landfill compactor, a pneumatic roller, a tandem vibratory roller, and the like. Further, the disclosure is not limited to a type of the compactor 100 and may include any other machine that includes one or more drums or vibratory systems.

The compactor 100 includes a frame 102. The frame 102 supports various components of the compactor 100 thereon. The compactor 100 defines a front end 104 and a rear end 106 opposite the front end 104. The compactor 100 includes a power source (not shown) disposed within an enclosure defined by the frame 102. Various components of the compactor 100 are operated by the power source. The power source may be an engine, such as, an internal combustion engine, a fuel cell, a battery system, and the like, without limiting the scope of the present disclosure. The compactor 100 further includes an operator cabin 110. An operator may be seated within the operator cabin 110 to perform and/or observe compaction operations.

The compactor 100 includes a drum 114, 116 coupled to the frame 102. Specifically, the compactor 100 includes a pair of drums 114, 116 herein. The pair of drums 114, 116 include a first drum 114 disposed at the front end 104 of the compactor 100 and a second drum 116 disposed at the rear end 106 of the compactor 100. The drum 114 is hereinafter interchangeably referred to as “the first drum 114” and the drum 116 is hereinafter interchangeably referred to as “the second drum 116”. The first drum 114 and the second drum 116 may be similar to each other in terms of design and functionality. The first drum 114 and the second drum 116 together support the frame 102 of the compactor 100 and allow the compactor 100 to move over a ground surface. Further, the first drum 114 and the second drum 116 contact a work surface to perform a compaction operation for compacting materials, such as, asphalt, soil, gravel, and the like. Each of the first drum 114 and the second drum 116 includes an outer shell 112. The outer shell 112 contacts the work surface during the compaction operation, or during mobility of the compactor 100. In another example, the compactor 100 may include a single drum and a pair of wheels, instead of two drums 114, 116.

The compactor 100 further includes a vibration system 120, 122 disposed within the drum 114, 116. The vibration system 120, 122 vibrates the drum 114, 116. Specifically, each drum 114, 116 includes a corresponding vibration system 120, 122. Accordingly, the compactor 100 includes two vibration systems 120, 122. The vibration system 120, 122 includes the vibration system 120 disposed within the first drum 114 to vibrate the first drum 114. The vibration system 120 includes a number of components, such as eccentric weights, an actuator, a shift fork, and the like that cause vibration of the first drum 114 at a desired amplitude of vibration.

The vibration system 120, 122 also includes the vibration system 122 disposed within the second drum 116 to vibrate the second drum 116. The vibration system 122 includes a number of components, such as, eccentric weights, an actuator, a shift fork, and the like that cause vibration of the second drum 116 at a desired amplitude of vibration.

The vibration system 120, 122 further includes a drive motor 124, 126. Specifically, the drive motor 124 is a first drive motor 124 associated with the vibration system 120 of the first drum 114 and the drive motor 126 is a second drive motor 126 associated with the vibration system 122 of the second drum 116. The drive motor 124 is hereinafter interchangeably referred to as “the first drive motor 124” and the drive motor 126 is hereinafter interchangeably referred to as “the second drive motor 126”.

The drive motor 124, 126 may be a hydraulic motor or an electric motor. In other examples, the drive motor 124, 126 may be a pneumatic motor, a stepper motor, a servo motor, a linear motor, a magnetic motor, and the like, without limiting the scope of the present disclosure.

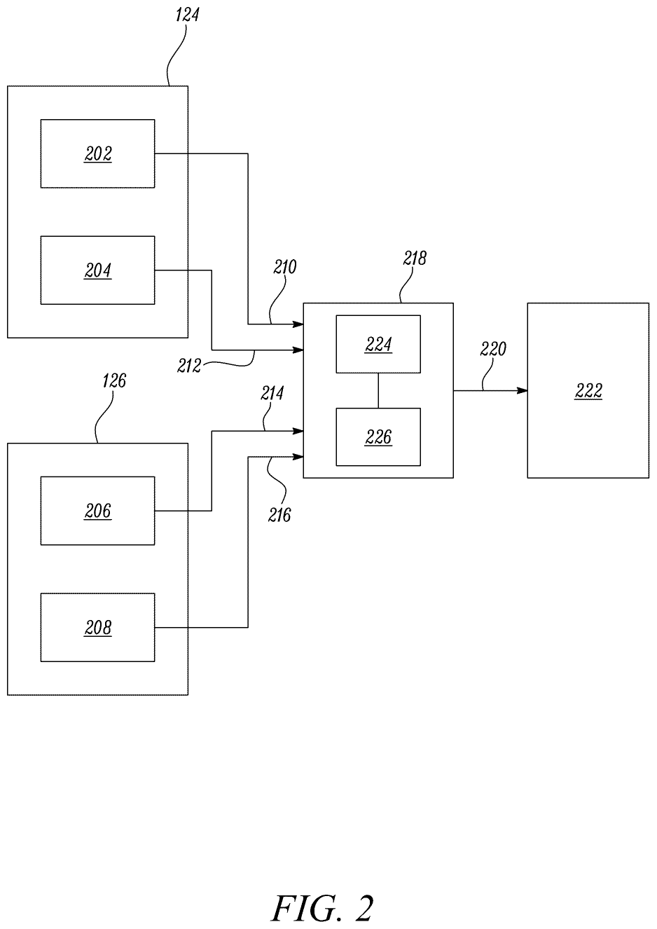

Referring to FIG. 2, a block diagram of a system 200 for determining a material compaction value associated with the compaction operation being performed by the compactor 100 is illustrated. The system 200 includes one or more accelerometers 202, 204, 206, 208 coupled to the drive motor 124, 126 of the compactor 100. The one or more accelerometers 202, 204, 206, 208 are disposed within the drive motor 124, 126. Specifically, the accelerometers 202, 204, 206, 208 may be disposed within a housing of the corresponding drive motor 124, 126. The one or more accelerometers 202, 204, 206, 208 generate an input signal 210, 212, 214, 216 indicative of an acceleration of the drive motor 124, 126. The input signal 210, 212, 214, 216 includes a fundamental frequency and a number of harmonic frequencies.

The accelerometers 202, 204 are disposed within the first drive motor 124 and generate the input signals 210, 212 indicative of the acceleration of the first drive motor 124. Further, the accelerometers 206, 208 are disposed within the second drive motor 126 and generate the input signal 214, 216 indicative of the acceleration of the second drive motor 126.

The one or more accelerometers 202, 204, 206, 208 includes a first accelerometer 202, 206 to generate a first input signal 210, 214 indicative of a vertical component of acceleration. Specifically, the first accelerometer 202 disposed in the first drive motor 124 generates the first input signal 210 indicative of the vertical component of acceleration of the first drive motor 124. Further, the first accelerometer 206 disposed in the second drive motor 126 generates the second input signal 212 indicative of the vertical component of acceleration of the second drive motor 126. The accelerometer 202 may be hereinafter interchangeably referred to as “the first accelerometer 202” and the accelerometer 206 may be hereinafter interchangeably referred to as “the first accelerometer 206”. The input signal 210 may be hereinafter interchangeably referred to as “the first input signal 210” and the input signal 214 may be hereinafter interchangeably referred to as “the first input signal 214”.

The one or more accelerometers 202, 204, 206, 208 also includes a second accelerometer 204, 208 to generate a second input signal 212, 216 indicative of a horizontal component of acceleration. Specifically, the second accelerometer 204 disposed in the first drive motor 124 generates the second input signal 212 indicative of the horizontal component of acceleration of the first drive motor 124. Further, the second accelerometer 208 disposed in the second drive motor 126 generates the second input signal 216 indicative of the horizontal component of acceleration of the second drive motor 126. The accelerometer 204 may be hereinafter interchangeably referred to as “the second accelerometer 204” and the accelerometer 208 may be hereinafter interchangeably referred to as “the second accelerometer 208”. The input signal 212 is hereinafter interchangeably referred to as “the second input signal 212” and the input signal 216 is hereinafter interchangeably referred to as “the second input signal 216”.

The system 200 also includes a controller 218 communicably coupled with the one or more accelerometers 202, 204, 206, 208. The controller 218 receives the input signal 210, 212, 214, 216 indicative of the acceleration of the drive motor 124, 126 from the one or more accelerometers 202, 204, 206, 208.

Specifically, the controller 218 is communicably coupled with the first and second accelerometers 202, 204 disposed within the first drive motor 124 to receive the input signals 210, 212. Further, the controller 218 is communicably coupled with the first and second accelerometers 206, 208 disposed within the second drive motor 126 to receive the input signals 214, 216.

Further, the controller 218 determines the material compaction value associated with the compaction operation based on the input signals 210, 212, 214, 216 indicative of the acceleration of the drive motor 124, 126.

The controller 218 determines the material compaction value based on each of the first input signal 210, 214 and the second input signal 212, 216. In other words, the controller 218 takes into consideration the first input signal 210, 214 indicative of the vertical component of acceleration of the drive motors 124, 126 as well as the second input signal 212, 216 indicative of the horizontal component of acceleration of the drive motors 124, 126.

Further, the controller 218 determines a first amplitude AΩ of the input signal 210, 212, 214, 216 at the fundamental frequency. The controller 218 also determines a second amplitude A2Ω of the input signal 210, 212, 214, 216 for at least the second harmonic of the fundamental frequency. Further, the controller 218 compares the first amplitude AΩ and the second amplitude A2Ω to determine the material compaction value.

In an example, the controller 218 may use the following equation to determine the material compaction value,

$$MCV = C \cdot \frac{A 2 Ω}{A Ω}$$

where, MCV is the material compaction value, C is a constant that is variable and depends on compactor specifications and materials being compacted, AΩ is the first amplitude, and A2Ω is the second amplitude. However, the controller 218 may use any other equation or technique to determine the material compaction value based on the input signals 210, 212, 214, 216.

The controller 218 includes one or more memories 226. The one or more memories 226 may store the constant C. The one or more memories 226 may include any means of storing information, including a hard disk, an optical disk, a floppy disk, ROM (read only memory), RAM (random access memory), PROM (programmable ROM), EEPROM (electrically erasable PROM), or other computer-readable memory media.

The controller 218 also includes one or more processors 224. The one or more processors 224 are communicably coupled with each of the one or more memories 226 and the one or more accelerometers 202, 204, 206, 208. The processors 224 may determine the material compaction value based on the receipt of the input signals 210, 212, 214, 216.

It should be noted that the one or more processors 224 may embody a single microprocessor or multiple microprocessors for receiving various input signals and generating output signals. Numerous commercially available microprocessors may perform the functions of the one or more processors 224. The one or more processors 224 may further include a general processor, a central processing unit, an application specific integrated circuit (ASIC), a digital signal processor, a field programmable gate array (FPGA), a digital circuit, an analog circuit, a microcontroller, any other type of processor, or any combination thereof. The one or more processors 224 may include one or more components that may be operable to execute computer executable instructions or computer code that may be stored and retrieved from the one or more memories 226.

The controller 218 further generates an output signal 222 indicative of the material compaction value associated with the compaction operation being performed by the compactor 100.

The system 200 further includes an output module 220 communicably coupled with the controller 218 to receive the output signal 222 indicative of the material compaction value. The output module 220 displays the material compaction value thereon. The output module 220 may be a display screen, a speaker, a smartphone, a tablet, and the like. The output module 220 may be disposed inside the operator cabin 110 (see FIG. 1). Alternatively, the output module 220 may be disposed outside the operator cabin 110, so that the operator present outside the compactor 100 may be notified of the material compaction value associated with the compaction operation.

In some examples, the controller 218 may also determine a health of the drive motors 124, 126 based on the input signals 210, 212, 214, 216 received from the accelerometers 202, 204, 206, 208. For example, the controller 218 may generate diagnostic information related to a health of the drive motors 124, 126 based on increased vibration levels or frequency analysis to determine an imbalance of motor components, misalignment between components of the drive motors 124, 126, a malfunction such as an electric malfunction, and the like.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the system 200 for determining the material compaction value associated with the compaction operation being performed by the compactor 100. The system 200 includes the one or more accelerometers 202, 204, 206, 208 coupled to the drive motor 124, 126 of the compactor 100. The one or more accelerometers 202, 204, 206, 208 are disposed within the drive motor 124, 126 and generate the input signals 210, 212, 214, 216. Further, the system 200 also includes the controller 218. The controller 218 receives the input signals 210, 212, 214, 216 and determines the material compaction value indicative of the acceleration of the drive motor 124, 126 based on the input signals 210, 212, 214, 216.

Furthermore, the one or more accelerometers 202, 204, 206, 208 may be disposed within the drive motor 124, 126 or may include existing accelerometers present within the drive motor 124, 126. The accelerometers 202, 204, 206, 208 may not require an additional wire harness for operation, which may reduce part numbers as well as cost and complexity associated with determining the material compaction value. Further, the system 200 allows an accurate determination of the material compaction value by using the accelerometers 202, 204, 206, 208, as the accelerometers 202, 204, 206, 208 provide both the vertical and horizontal components of the acceleration. Moreover, the system 200 may prevent uneven compaction and material damage/wastage by alerting the operator about the material compaction value.

Additionally, the one or more accelerometers 202, 204, 206, 208 of the system 200 may be used for diagnosing the health of the drive motors 124, 126. The controller 218 may generate the diagnostic information which may alert the operator that the drive motor 124, 126 may need to be examined, serviced, or replaced in order to maintain an efficiency of the compactor 100. Further, the system 200 may reduce repair costs, servicing timelines, and/or downtime of the compactor 100 by alerting operators regarding the health of the drive motor 124, 126.

Overall, the system 200 is simple in construction and does not include complex components for operation. Further, the system 200 may improve an operating time and the efficiency of the compactor 100. Furthermore, the system 200 may be cost-effective, may be retrofitted on existing compactors, and may be easy to implement on compactors.

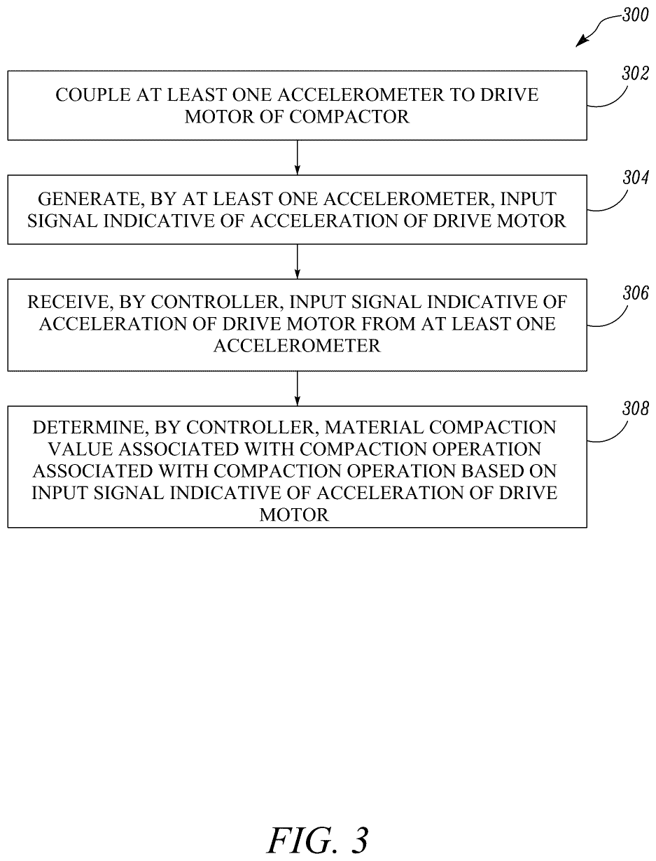

FIG. 3 is a flowchart of a method 300 for determining the material compaction value associated with the compaction operation being performed by the compactor 100. With reference to FIGS. 1 to 3, at step 302, the one or more accelerometers 202, 204, 206, 208 are coupled to the drive motor 124, 126 of the compactor 100. The step 302 further includes disposing the one or more accelerometers 202, 204, 206, 208 within the drive motor 124, 126.

At step 304, the one or more accelerometers 202, 204, 206, 208 generate the input signal 210, 212, 214, 216 indicative of the acceleration of the drive motor 124, 126.

At step 306, the controller 218 receives the input signal 210, 212, 214, 216 indicative of the acceleration of the drive motor 124, 126 from the one or more accelerometers 202, 204, 206, 208. The controller 218 is communicably coupled with the one or more accelerometers 202, 204, 206, 208.

At step 308, the controller 218 determines the material compaction value associated with the compaction operation based on the input signals 210, 212, 214, 216 indicative of the acceleration of the drive motor 124, 126. The one or more accelerometers 202, 204, 206, 208 include the first accelerometer 202, 206 that generates the first input signal 210, 214 indicative of the vertical component of acceleration. The one or more accelerometers 202, 204, 206, 208 also include the second accelerometer 204, 208 that generates the second input signal 212, 216 indicative of the horizontal component of acceleration. The step 308 further includes determining of the material compaction value by the controller 218 based on each of the first input signal 210, 214 and the second input signal 212, 216.

The input signal 210, 212, 214, 216 includes the fundamental frequency and the number of harmonic frequencies. The method 300 further includes a step (not shown) at which the controller 218 determines the first amplitude AΩ of the input signal 210, 212, 214, 216 at the fundamental frequency. The method 300 further includes a step (not shown) at which the controller 218 determines the second amplitude A2Ω of the input signal 210, 212, 214, 216 for at least the second harmonic of the fundamental frequency. The method 300 further includes a step (not shown) at which the controller 218 compares the first amplitude AΩ and the second amplitude A2Ω to determine the material compaction value.

The method 300 further includes a step (not shown) at which the output module 220 is communicably coupled with the controller 218 to receive the output signal 222 indicative of the material compaction value. The method 300 further includes a step (not shown) at which the output module 220 displays the material compaction value thereon.

It should be noted that the steps 302, 304, 306, 308 of the method 300 may be performed in a sequence that is different from that explained in relation to FIG. 3. Further, various steps 302, 304, 306, 308 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A system for determining a material compaction value associated with a compaction operation being performed by a compactor, the system comprising:
at least one accelerometer coupled to a drive motor of the compactor, wherein the at least one accelerometer is configured to generate an input signal indicative of an acceleration of the drive motor; and
a controller communicably coupled with the at least one accelerometer, wherein the controller is configured to:
receive, from the at least one accelerometer, the input signal indicative of the acceleration of the drive motor; and
determine the material compaction value associated with the compaction operation based on the input signal indicative of the acceleration of the drive motor.

2. The system of claim 1, wherein the at least one accelerometer includes a first accelerometer configured to generate a first input signal indicative of a vertical component of acceleration.

3. The system of claim 2, wherein the at least one accelerometer includes a second accelerometer configured to generate a second input signal indicative of a horizontal component of acceleration.

4. The system of claim 3, wherein the controller is configured to determine the material compaction value based on each of the first input signal and the second input signal.

5. The system of claim 1, wherein the at least one accelerometer is disposed within the drive motor.

6. The system of claim 1 further comprising an output module communicably coupled with the controller to receive an output signal indicative of the material compaction value, wherein the output module is configured to display the material compaction value thereon.

7. The system of claim 1, wherein the input signal includes a fundamental frequency and a plurality of harmonic frequencies, and wherein the controller is configured to:
determine a first amplitude of the input signal at the fundamental frequency;
determine a second amplitude of the input signal for at least the second harmonic of the fundamental frequency; and
compare the first amplitude and the second amplitude to determine the material compaction value.

8. A compactor comprising:
a frame;
a drum coupled to the frame;
a vibration system disposed within the drum and adapted to vibrate the drum, wherein the vibration system includes a drive motor; and
a system for determining a material compaction value associated with a compaction operation being performed by the compactor, the system including:
at least one accelerometer coupled to the drive motor of the compactor, wherein the at least one accelerometer is configured to generate an input signal indicative of an acceleration of the drive motor; and
a controller communicably coupled with the at least one accelerometer, wherein the controller is configured to:
receive, from the at least one accelerometer, the input signal indicative of the acceleration of the drive motor; and
determine the material compaction value associated with the compaction operation based on the input signal indicative of the acceleration of the drive motor.

9. The compactor of claim 8, wherein the at least one accelerometer includes a first accelerometer configured to generate a first input signal indicative of a vertical component of acceleration.

10. The compactor of claim 9, wherein the at least one accelerometer includes a second accelerometer configured to generate a second input signal indicative of a horizontal component of acceleration.

11. The compactor of claim 10, wherein the controller is configured to determine the material compaction value based on each of the first input signal and the second input signal.

12. The compactor of claim 8, wherein the at least one accelerometer is disposed within the drive motor.

13. The compactor of claim 8, wherein the system further includes an output module communicably coupled with the controller to receive an output signal indicative of the material compaction value, and wherein the output module is configured to display the material compaction value thereon.

14. The compactor of claim 8, wherein the drive motor is a hydraulic motor or an electric motor.

15. The compactor of claim 8, wherein the input signal includes a fundamental frequency and a plurality of harmonic frequencies, and wherein the controller is configured to:
determine a first amplitude of the input signal at the fundamental frequency;
determine a second amplitude of the input signal for at least the second harmonic of the fundamental frequency; and
compare the first amplitude and the second amplitude to determine the material compaction value.

16. A method for determining a material compaction value associated with a compaction operation being performed by a compactor, the method comprising:
coupling at least one accelerometer to a drive motor of the compactor;
generating, by the at least one accelerometer, an input signal indicative of an acceleration of the drive motor; and
receiving, by a controller, the input signal indicative of the acceleration of the drive motor from the at least one accelerometer, wherein the controller is communicably coupled with the at least one accelerometer; and
determining, by the controller, the material compaction value associated with the compaction operation based on the input signal indicative of the acceleration of the drive motor.

17. The method of claim 16, wherein the at least one accelerometer includes a first accelerometer configured to generate a first input signal indicative of a vertical component of acceleration, wherein the at least one accelerometer includes a second accelerometer configured to generate a second input signal indicative of a horizontal component of acceleration, and wherein the step of determining, by the controller, the material compaction value further includes:
determining, by the controller, the material compaction value based on each of the first input signal and the second input signal.

18. The method of claim 16, wherein the step of coupling the at least one accelerometer to the drive motor of the compactor further includes:
disposing the at least one accelerometer within the drive motor.

19. The method of claim 16 further comprising:
communicably coupling an output module with the controller to receive an output signal indicative of the material compaction value; and
displaying, by the output module, the material compaction value thereon.

20. The method of claim 16, wherein the input signal includes a fundamental frequency and a plurality of harmonic frequencies, and wherein the step of determining, by the controller, the material compaction value further includes:
determining, by the controller, a first amplitude of the input signal at the fundamental frequency;
determining, by the controller, a second amplitude of the input signal for at least the second harmonic of the fundamental frequency; and
comparing, by the controller, the first amplitude and the second amplitude to determine the material compaction value.
